(19) United States
(12) Patent Application Publication
(10) Pub. No.: US 2009/0077876 A1
(43) Pub. Date: Mar. 26, 2009

(54) Expandable plant growing frame tray and pots

(76) Inventors: Morteza Eghbal, Rancho Cucamonga, CA (US); Sabrina D. Golfo, Rancho Cucamonga, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/903,642

(22) Filed: Sep. 25, 2007

(51) Int. Cl. A47G 7/04; A01G 9/02

(52) U.S. Cl. 47/18; 47/39

(57) ABSTRACT

An expandable plant growing frame is disclosed. The expandable growing frame includes a unique tubular joiner that works with standard tubing to allow the frame to grow to accommodate growth of a nursery. The tubular joiner can be shipped and assembled using locally available plastic tubing. The tubular joiners are usable to create an expandable table for purposes including but not limited to growing tables, display tables and dining tables. A tray is disclosed that rests on the tubular frame and allows for an expandable planting table. Elongated pots are also disclosed that provide the equivalent volume as more standard sized round pots. The elongated pots can interconnect to making it easier to carry a number of pots. The pots nest within the tray to increase the quantity of plants that are grown at one time.

### FIELD OF THE INVENTION

This invention relates to an expandable growing frame with planters. More particularly, the expandable growing frame includes a unique multi ported tubular joiner that-works with standard tubing to allow the frame to grow to accommodate growth of a nursery. Elongated pots are used to increase the quantity of plants that are grown at one time. The elongated plants are placed in a matrix tray that engages on the frame structure. Furthermore the expandable frame is usable in any field where an expandable modular frame is needed.

### BACKGROUND OF THE INVENTION

Most nurseries generally start with seeds or cuttings to grow their plants. The object of these nurseries is to maximize the growing area. One of the major problems with a nursery is to accommodate the different growing seasons and growth of the company. To minimize the capital expense to make growing benches a nursery will use materials that are cost effective or readily available. Some examples of the growing benches, trays and planting pots are disclosed in the patents identified herein.

U.S. Patents that disclose connecting tubular members to make an expandable bench include U.S. Pat. No. 4,023,913 issued May 17, 1997 to Irving L. Berkowitz, U.S. Pat. No. 3,255,721 issued Jun. 14, 1966 to P. L. Peterschmidt, U.S. Pat. No. D409,083 issued May 4, 1999 to Patrik L. T. Bernstein and U.S. Pat. No. D282,129 issued Jan. 14, 1986 to Harry Glück discloses tubular connection pieces for making an expandable frame. While these patents disclose connection pieces for use with tubing they close the ends of the tubes and are not slidably connected to multiple tubes passing through the connecting pieces.

U.S. Patents that disclose a growing bench includes U.S. Pat. No. 6,394,006 issued May 28, 2002 to Robert L. Hoekstra et al., U.S. Pat. No. 6,029,399 issued Feb. 29, 2000 to Wayne A. Mercer and U.S. Pat. No. 4,756,199 issued Jul. 12, 1988 disclose growing benches for a finite number of plants based upon the grid matrix or the size of the table. While these patents disclose a growing table they are limited to the number of plants that can be grown at a single time and the matrix is not expandable.

U.S. Patents that disclose elongated growing containers include U.S. Pat. No. 4,242,834 issued Jan. 6, 1981 to Robert C. Olsen and U.S. Pat. No. 3,142,133 issued Jul. 28, 1964 to R. P. Brooks disclose elongated (tall) planting flats for seeds or seedlings. While elongated (tall) planting pots are disclosed they are connected as a flat of pots and are limited in size for use with small plants.

U.S. Patents that disclose trays include U.S. Pat. No. 6,266,919 issued Jul. 31, 2001 to Stanley J. Hoium, Jr. et al., U.S. Pat. No. 3,825,126 issued Jul. 23, 1974 to Sigfried Pohl et al., and U.S. Pat. No. 3,542,210 issued Nov. 24, 1970 to Jens Ole Sorensen disclose a planting grate-type frames for use with potted plants. While a frame is disclosed the frame is not ideally suited for use on a tubular structure where the frames can be connected, engaged on the tubular structure and expanded.

What is needed is a tubular interconnecting member that is used with tubular where the tubing can slide through the interconnecting members to make a growing bench that is virtually infinite in length. The tubular growing frame should accept a frame for accepting pots that are configured for optimal growing density. The proposed expandable plant growing frame tray and pots provides a complete solution to accommodate these needs.

### BRIEF SUMMARY OF THE INVENTION

It is an object of the expandable plant growing system to utilize a multi port joiner that can utilize standard pipes. This joiner allows the plant growing system to be easily expanded to accommodate more plants. The use of standard piping reduces the shipping cost of the system because a user can purchase a quantity of multi port joiners that are easily shipped and then the user can purchase piping from a local source to complete the assembly. The multi port joiner includes a flat portion on the outer diameter of the ports for drilling or screwing to fixedly secure the standard pipes into the multi port joiners.

It is an object of the expandable plant growing system to use the standard pipes that pass through the multi port joiner without cutting the pipes. Since the pipes remain as continuous tube the pipes are still usable for the supply of water for irrigation or for heating.

It is an object of the expandable plant growing system to provide foot pads that are used on the ends of the standard pipes that are installed within the multi port joiner to elevate the plant growing structure. Since the user or installer cuts the legs from standard pipes the height of the growing table can be made any desired height.

It is an object of the expandable plant growing system to make a growing system that is expandable from a single growing bench using only four multi port joiners to a nearly infinite length growing bench using multiple sets of multi port joiners to make larger growing tables.

It is another object of the expandable multi ported tubular joiner to use the multi ported tubular joiner to make a table structure that is expandable to accommodate a number of different uses including but not limited to assembly line tables and dining tables and the like. The multi ported tubular structure makes it ideal for compact storage when not used and quick assembly when needed with expandability to accommodate additional table needs.

It is still another object of the expandable plant growing system to utilize structural flats that engage onto the tubes of the growing structure the flats are made with tapered sides to nest multiple trays for storage or shipping. The engagement of the flats onto the tubes maintain the flats from movement off of the growing table but still allows the flats to be slid along the tubes that form the growing table.

It is yet another object of the expandable plant growing system to include square pots that nest into the flats. The square pots provide the advantage of increasing the density of the plants that are grown by maximizing the volume of soil that is used. The square pots are also fabricated in a tall configuration to promote longer roots and to allow the pots to be placed closer. The pots are configured with tapered sides to allow the pots to be nested to reduce the storage and shipping size.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of a multi ported tubular joiner.

FIG. 2 shows an isometric view of a supporting foot pad.

FIG. 3 shows an isometric view of an elongated pot.

FIG. 4 shows a top isometric view of a pot tray.

FIG. 5 shows a bottom isometric view of a pot tray

FIG. 6 shows an isometric view of an assembly of the expandable plant growing frame showing the components.

FIG. 7 shows an isometric view of a two pot holder for a pole.

FIG. 8 shows a second isometric view of a two pot holder for a pole.

FIG. 9 shows an isometric view of multiple two pot holders spaced around a pole.

FIG. 10 shows a second isometric view of multiple two pot holders spaced around a pole.

FIG. 11 shows a cake pot planter.

FIG. 12 shows a cake pot planter with a pole extending from a base with multiple pot holders.

### DETAILED DESCRIPTION

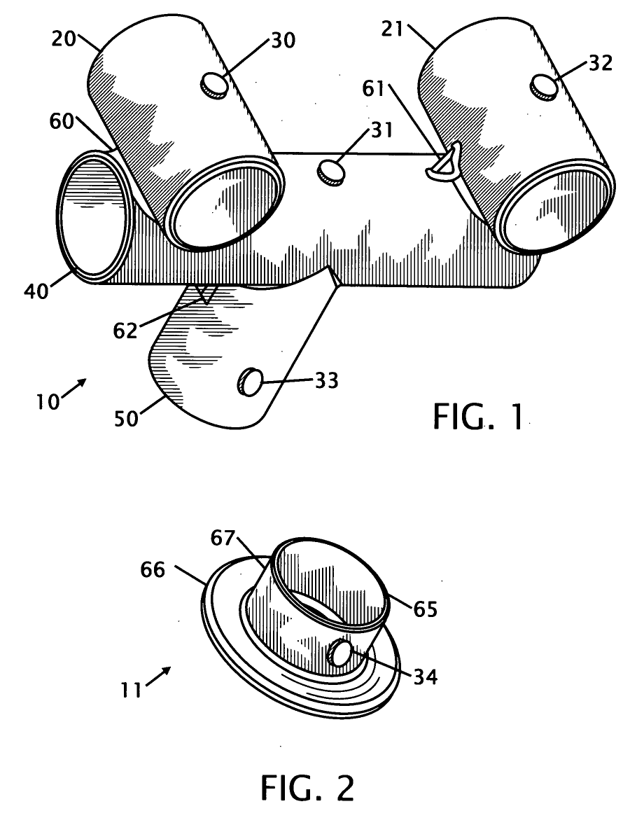

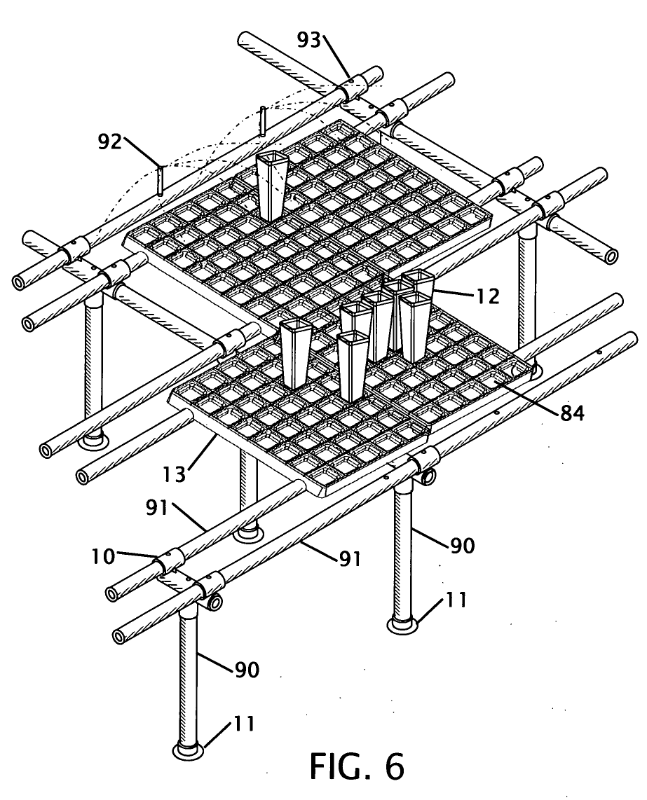

FIG. 1 shows an isometric view of a multi ported tubular joiner 10. This multi ported joiner allows standard plumbing pipes to be inserted through the holes and then slid to the desired position. The material of the multi port joiner is made from materials including but not limited to plastics, metals or ceramics. In the preferred embodiment the multi port joiner is molded from a plastic material such as ABS or PVC. FIG. 6 shows an assembly drawing of the multi port joiner used with piping. The multi port joiner has a bottom hole 50 where a leg post is placed to establish the height of the assembled growing bench. It is contemplated that hole 50 is configured with a diameter that tightly secures a leg post placed in hole 50. The leg can be glued into hole 50 using conventional plastic pipe adhesives. In an alternate method of assembling the leg post into the multi port joiner a flat 33 is provided where screw can be placed to removably secure the leg post within the multi port joiner.

In operation at least two parallel ports 20 and 21 are used where standard pipes are passed through these ports. Depending upon the weight of the plants that are being grown on the frame the spacing between several multi port joiners is variable and can be changed because the pipes placed through these two parallel ports are not fixed. The only limit to movement of pipes on the multi port joiner is with the coupling that is used to join two pipes. Flat pads 30 and 32 are placed on the outer diameter of the parallel ports to provide a flat surface for drilling or inserting a screw to hold the pipe(s) in position. While only two parallel ports are shown in this preferred embodiment it is contemplated that more than two parallel ports can be used to accomplish a similar result.

A third port 40 is placed perpendicular to the at least two parallel ports. This third port runs under both of the two parallel ports without intersecting these two ports. The pipe that is placed though this port is also not rigidly placed to allow the pipe to slide within the port. The sliding arrangement provides to option allows the multi port joiners to be closer or further together based upon the weight of the material being placed on the growing bench. A flat pad 31 is placed on the outer diameter of the third port to provide a flat surface for drilling or inserting a screw to hold the pipe in position.

The leg port 50 is a fourth port that intersects the at least third port and is perpendicular to the two parallel ports and the at least one third port. Gussets 62, ribs 61 and other strengthening members 60 are incorporated to increase the structural strength and rigidity of the multi port joiner 10.

FIG. 2 shows an isometric view of a supporting foot pad 11. The foot pad 11 is used on the bottom of a leg post to distribute the load of the growing table and the plant placed on the growing table. The foot pad comprises of a vertical cup 67 with an open upper edge 65. The leg post is placed into the cup. It is contemplated that the fit between the leg post and the foot pad 11 prevents free movement of the leg post and the foot pad 11. A flat pad 34 is placed on the outer diameter of the foot pad to provide a flat surface for drilling or inserting a screw to hold the pipe(s) in position. In the embodiment shown an elongated pad 66 extends from the cylindrical cup. The size and shape of the pad is variable based upon the weight that is being distributed as well as the type of ground the foot pad is being placed upon.

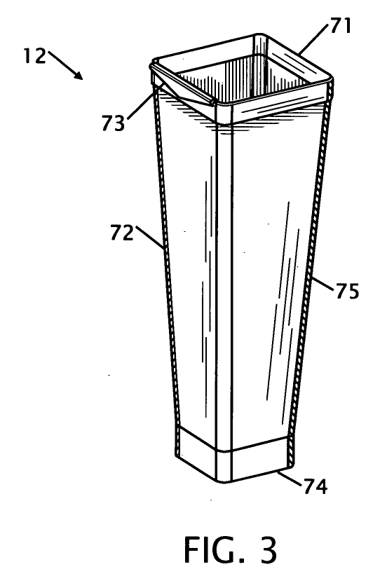

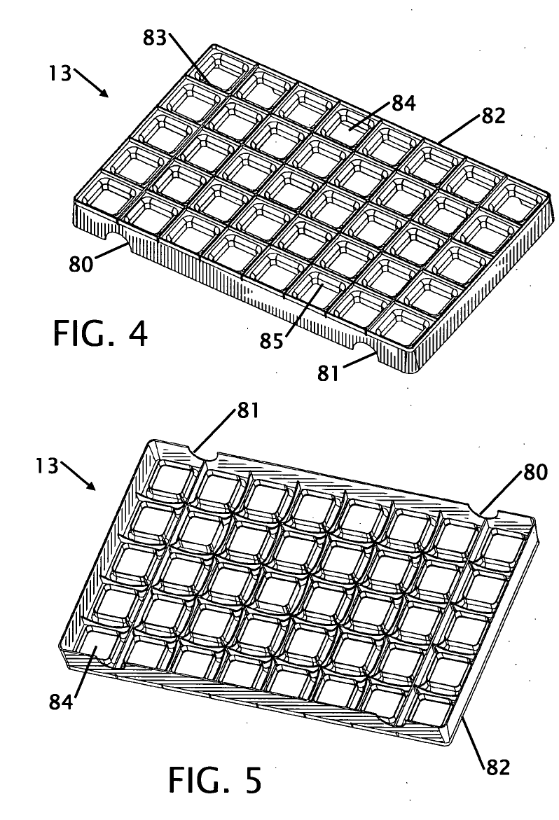

FIG. 3 shows an isometric view of a pot 12. The pot is configured as an elongated rectangular tapered 72 cylinder with a base 74. The lower portion of the base 75 has straighter sides to engage within a growing tray that is described in more detail with FIGS. 4 and 5. In the preferred embodiment the pot 12 is configured as a one quart or one gallon size. The height and the rectangular opening on the pot provide a significant increase in the density of plants that can be placed in a nursery. One or two upper lip(s) of the pot are hooked 73 to engage over the upper edge 71 of adjoining pots. The hooked upper edge(s) allows multiple pots to be interconnected making them easier to lift and carry. A typical round one gallon pot is 6.5 inches in diameter and 7 inches tall. In one contemplated embodiment a one gallon pot 12 is configured with a squared opening of 4.5 inches and a height of 12 inches. This configuration provides a 50% reduction in the space needed to grow a plant in a one gallon elongated pot 12. Another advantage of using tall pots with these dimension is that the hole can be dig with a standard post hole digger.

FIG. 4 shows a top isometric view of a pot tray and FIG. 5 shows a bottom isometric view of a pot tray 13. The tray 13 shown provides placement of 40 plants per tray. The tray has a matrix of open cavities 84 having eight cavities on one direction and five cavities in the other direction. While 40 plants per tray is shown it is contemplated that the number of plants that are placed into a tray is variable based upon the size and weight of the plants placed in the trays. It is contemplated that the tray size accommodates the ability of a person to lift an entire loaded tray. The tray 13 is made from a raised thin walled material where the vertical raised structure of the tray provides structural strength to the tray. An outer edge 82 defines the perimeter of the tray with a matrix of raised interconnecting ribs 83 that defines the matrix. The inner walls 85 of the matrix define open cavities where the bottom portion 74 of the tall pots 12 (from FIG. 3) engage into the matrix. Two radiused saddles 80 and 81 extend through the bottom of the tray. These radiused saddles sit on the tubes from the growing frame. The radius helps position the tray on the frame and maintains the tray from falling off the frame without limiting the ability to slide the tray along the tubes of the frame.

FIG. 6 shows an isometric view of an assembly of the expandable plant growing frame showing the components. The expandable frame allows for a simple table with four legs to a long table with many sets of legs and tubes. From this figure a section of the growing table is shown with multiple sets of the multi ported tubular joiners 10 connected through. pipes 91. The multi ported tubular joiners are supported on vertical legs 90 that are terminated with foot pads 11. The structure is constructed such that the radiused saddles in trays 13 fit onto pipes 91. The pipes 91 are standard plumbing, gas, irrigation or electrical pipes or tubing that are available in sizes including but not limited to ½″, ¾″, 1-¼″, 1-½″, 2″,2-½″, 3″, 4″, 5″, 6″ and 8 but other sizes are contemplated. In most cases these pipes can be acquired from a local hardware store, and in other cases these pipes are being used by nurseries. In operation a user first cuts the leg pieces 90 and assembles them onto the foot pads 11 and the multi ported tubular joiners 10. They then pass tubes 91 through the ports of the multi ported tubular joiner 10 and the spacing between the multi port tubular joiners is adjusted. Screws 93 can be placed through the flats on the. multi ported tubular joiner to rigidly secure the tubing on the structure. Trays 13 are placed on the tubes 91 of the frame where they are maintained or are repositioned as desired. The pots 12 are placed within the holes 84 of the trays 13. Since the integrity of the pipes may not be compromised the pipes can be used to transport water for irrigation or heating. The transportation of water can be used to power misters or irrigation heads 92 can be installed into the tubes 91 to water the plants. The multi ported tubularjoiner provides the benefits of an expandable growing table and it eliminates the need for running additional watering and heating pipes

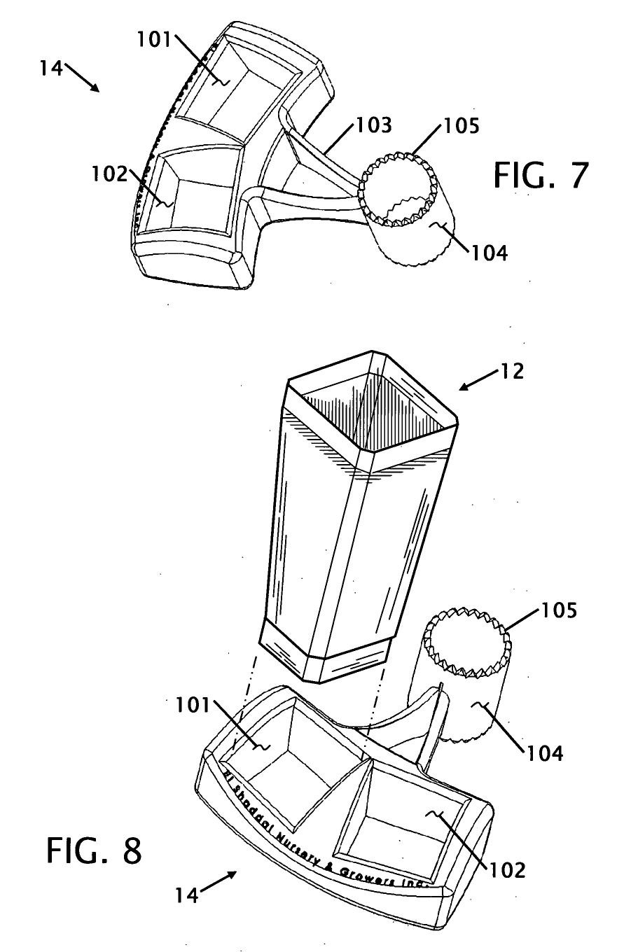

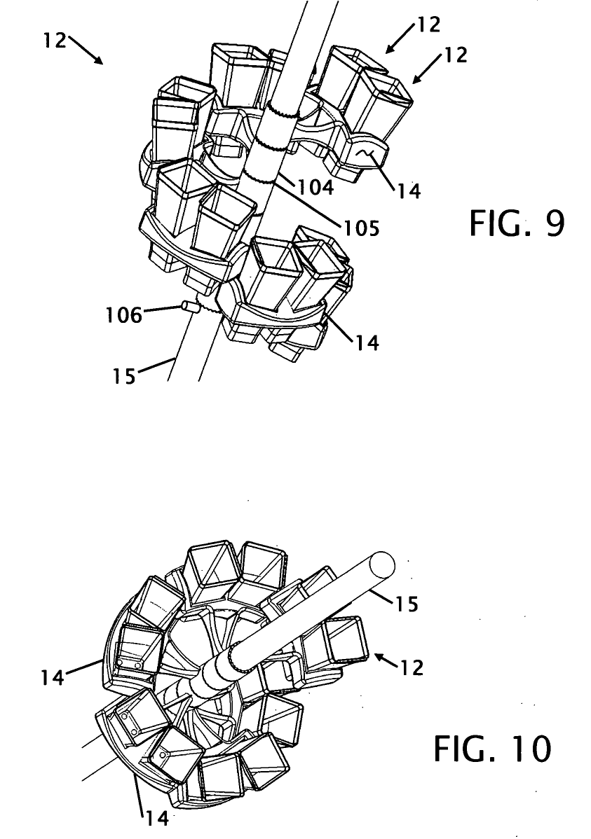

FIG. 7 and FIG. 8 show isometric views of a two pot holder 14 for a pole. The two pot holder 14 is configured from a cylindrical hub 104 with serrated teeth 105 on the upper and lower ends of the cylindrical hub. In the figure shown the serrated teeth are triangular in shape but other shaped teeth 105 are contemplated including but not limited to sinusoidal or square. The serrated teeth allow each stacked plant growing pot holder to be offset between 45 and 180 degrees. The offset is shown and described in more detail in FIGS. 9 and 110. At least one support arm 103 extending from the cylindrical hub, and in the figure shown two arms extend from the central hub 105 to a holder for retaining a plurality of pots 101 and 102 extending from the at least one support arm. While the holder 14 shown is configured to hold two pots other configurations are contemplated that will hold more than two pots in a side-by-side arrangement as well as an arrangement that holds three pots with two outer pots and a single inner pot being held. In FIG. 8 a pot 12 is shown where it would slide into the pot holder 14. The cylindrical hub 104 is configured for placement around a pole or rod and the serrated teeth provide offset spacing of a plurality of plant growing pot holders that are stacked on the pole or rod shown in FIGS. 9 and 10.

FIG. 9 and FIG. 10 show isometric views of multiple two pot holders spaced around a pole 15. The pole or rod is a standard plumbing electrical, gas, electrical or irrigation tubing of ½″, ¾″, 1″, 1-¼″, 1-½″, 2″, 2-½″, 3″, 4″, 5″, 6″ and 8″ pipe. The size of the pot holder 14 is variable based upon the size of the pipe that will be used. It is contemplated that the pole or rod 15 can be used to transport water for irrigation, heating or cooling of plants. It is contemplated that the starting height of the pot holders on the pole or rod 15 can be established by a pin 106 or a locking collar. The serrated teeth 105 allows each stacked plant growing pot holder 14 to be offset between 45 and 180 degrees. In the preferred embodiment shown the holders are offset 60 degrees. The elongated pots 12 have an essentially square planting opening with an interior volume of a quart or a gallon. The stacked plant growing pot holders 14 are offset in a spiral-configuration the height of the cylindrical hub 104 spaces each plant growing pot holder 14 to provide clearance for a plant growing in each pot 12.

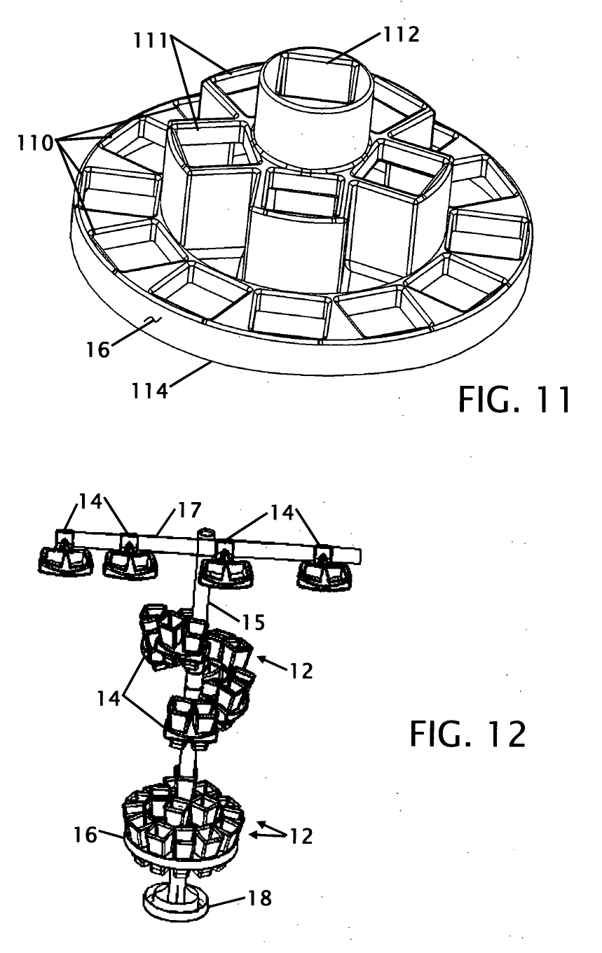

FIG. 11 shows a cake pot planter 16. The cake pot planter 16 is a circular tray having a plurality of-pot storing layers. In the preferred embodiment the bottom tier 110 has locations for holding 12 pots, the middle tier 111 has locations for holding five pots and the top tier 112 holds one pot. While the embodiment shows holders for a specific number of pots, it is contemplated that a cake pot planter can include more or less pot holder and more or less tiers. The base 114 of the cake pot planter 16 is configured for use over a standard pot or five gallon bucket.

FIG. 12 shows a cake pot planter 16 with a pole 15 extending from a base 18 with multiple pot holders 14. This figure shows the versatility of the plant growing system. In this figure the cake pot planter 16 is mounted onto a pole 15 that extends through the center of the cake pot planter 16. The pole 15 is supported on a base member 18. A plurality of plant growing pot holders 14 are secured onto the pole 15 and connected in a spiral configuration. At the top of the pole 15 a cross member pole 17 is connected and a plurality of plant growing pot holders 14 are secured to the cross member pole 17. A plurality of pots 12 are shown placed in the cake pot planter 16 and the plant growing pot holders 14.

Thus, specific embodiments of an expandable plant growing system have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An expandable plant growing bench comprising:
a multi ported tubular joiner having at least two. parallel ports joined by at least one third port that is perpendicular to the at least two parallel ports;
at least one fourth port intersecting. to the at least one third port that is perpendicular to the at least two parallel ports and the at least one third port wherein;
the at least two parallel ports and the at least one third port are sized for clearance of tubing placed through the at least two parallel ports and the at least one third port such that
tubing is placed through the at least two parallel port and the at least one third port to create an expandable structural matrix utilizing multiple multi ported tubularjoiners with tubing placed through the at least two parallel ports and the at least one third port.

2. The expandable plant growing bench according to claim 1 that further includes a supporting leg that is placed in the at least one fourth port to elevate the structural matrix.

3. The expandable plant growing bench according to claim 2 that further includes a foot pad that is placed on the free end of the supporting leg.

4. The expandable plant growing bench according to claim 1 that further includes a tray configured in a matrix of openings and further comprises a plurality of saddles that engage upon the tubing placed through the at least two parallel ports.

5. The expandable plant growing bench according to claim 1 wherein the tubing is used to transport water for irrigation, heating or cooling of plants.

6. The expandable plant growing bench according to claim 1 wherein the multi ported tubular joiner includes at least one flat surface on the outer diameter of a port for drilling or screwing a fastener to fixedly retain the tubing placed through the port.

7. The expandable plant growing bench according to claim 4 that further includes elongated pots that engage in the tray.

8. The expandable plant growing bench according to claim 7 wherein the elongated pots includes at least one hooked lip that is engagable into a mating lip in a second elongated pot.

9. The expandable plant growing bench according to claim 8 wherein the elongated pots have an essentially square planting opening with an interior volume of a quart or a gallon.

10. The expandable plant growing bench according to claim 1 wherein the tubing is standard plumbing electrical, gas, electrical or irrigation tubing of ½″, ¾″, 1″, 1-¼″, 1-½″, 2″, 2-½″, 3″, 4″, 5″, 6″ and 8″ pipe.

11. The expandable plant growing bench according to claim 1 wherein the at least two parallel ports and the at least one third port do not intersect.

12. An expandable plant growing pot holder comprising:
a cylindrical hub with serrated teeth on the upper and lower ends of the cylindrical hub;
at least one support arm extending from the cylindrical hub;
a holder for retaining a plurality of pots extending from the at least one support arm wherein,
The cylindrical hub is configured for placement around a pole or rod and the serrated teeth provide offset spacing of a plurality of plant growing pot holders that are stacked on the pole or rod.

13. The expandable plant growing pot holder according to claim 12 wherein the pole or rod is standard plumbing electrical, gas, electrical or irrigation tubing of ½″, ¾″, 1″, 1-¼″, 1-½″, 2″, 2-½″, 3″, 4″, 5″, 6″ and 8″ pipe.

14. The expandable plant growing pot holder according to claim 13 wherein the pole or rod is used to transport water for irrigation, heating or cooling of plants.

15. The expandable plant growing pot holder according to claim 12 wherein the serrated teeth are triangular, sinusoidal or square.

16. The expandable plant growing pot holder according to claim 12 that further includes elongated pots that engage in the holder for retaining a plurality of pots.

17. The expandable plant growing pot holder according to claim 16 wherein the elongated pots have an essentially square planting opening with an interior volume of a quart or a gallon.

18. The expandable plant growing pot holder according to claim 12 wherein the plurality of pots is at least two.

19. The expandable plant growing pot holder according to claim 12 wherein the serrated teeth allows each stacked plant growing pot holder to be offset between 45 and 180 degrees.

20. The expandable plant growing-pot holder according to claim 16 wherein when the stacked plant growing pot holders are offset in a spiral configuration the height of the cylindrical hub spaces each plant growing pot holder to provide clearance for a plant growing in each pot.
